(19) United States
(12) Patent Application Publication
(10) Pub. No.: US 2023/0145597 A1
(43) Pub. Date: May 11, 2023

(54) WEB-BASED WIDGET FOR A WORKER RECOGNITION PLATFORM

(71) Applicant: Fair People for People, Inc., Frisco, TX (US)

(72) Inventors: James Martin Bunting, Dallas, TX (US); Evan Daniel Rallis, Austin, TX (US)

(21) Appl. No.: 18/053,656

(22) Filed: Nov. 8, 2022

Related U.S. Application Data
(60) Provisional application No. 63/277,234, filed on Nov. 9, 2021.

(51) Int. Cl. G06Q 10/06; G06F 3/04817

(52) U.S. Cl. CPC G06Q 10/06398; G06F 3/04817

(57) ABSTRACT

A distributed online worker recognition platform connects workers of an enterprise and customers, and provides a rating system for enabling workers to receive recognition for customer service. A web widget associated with the worker recognition platform is embeddable on a third-party website to facilitate acquisition of ratings or other recognition for workers in the worker recognition platform. The web widget may display a set of avatars associated with workers that are selected and displayed based on a ranking algorithm. The ranking algorithm may be based on historical ratings received for different workers and/or may be customized to the user accessing the website to select workers most likely to have recent interactions with the user.

### CROSS-REFERENCE TO RELATED APPLICATIONS

This application claims the benefit of U.S. Provisional Application No. 63/277,234 filed Nov. 9, 2021, which is incorporated by reference herein.

### BACKGROUND

### Technical Field

This application relates generally to a worker recognition platform and more specifically, to a web-based widget for facilitating collection of feedback for rating workers in the worker recognition platform.

### Description of Related Art

In today's economy, over 80 million service-sector employees operate with little or no permanent record of their hard work or accomplishments. While various platforms exist for sourcing reviews, comments, ratings, or other feedback relating to various products, services, or professionals, these platforms are not tailored to recognizing service-sector workers performing every-day tasks such as serving food, repairing cars, conducting retail sales, or preparing our morning coffee.

Most review platforms are structured to source feedback directly through their platform website or mobile application using online forms or other direct feedback mechanisms. However, reliance on such basic mechanisms alone often fails to drive sufficient quantity and quality of feedback. In order to ensure service-sectors workers receive well-deserved recognition, it is desirable to enable efficient and seamless mechanisms for allowing customers to provide ratings or other feedbacks.

### BRIEF DESCRIPTION OF THE DRAWINGS

FIG. 1 is an example embodiment of an online worker recognition platform.

FIG. 2 is an example embodiment of a client application for a worker recognition platform.

FIG. 3 is an example embodiment of a server application for a worker recognition platform.

FIG. 4 is a flowchart illustrating an example embodiment of a process for operating a worker recognition platform.

FIG. 5 is a set of interface screens associated with rating workers in a worker recognition platform.

FIG. 6 is an example embodiment of a manager interface for managing workers associated with an enterprise in a worker recognition platform.

FIG. 7 is another example embodiment of a manager interface associated with an enterprise in a worker recognition platform.

FIG. 8 is an example embodiment of a scannable code for accessing a ratings page in a worker recognition platform.

FIG. 9 is a set of interface screens for rating a worker and verifying the user in a worker recognition platform.

FIG. 10 is an example embodiment of a closed view of a web widget in a worker recognition platform.

FIG. 11 is an example embodiment of an animation scheme for animating avatars in a web widget of a worker recognition platform.

FIG. 12 is an example embodiment of a fanout interface of a web widget in a worker recognition platform.

FIG. 13 is an example embodiment of a process for operating a web widget in a worker recognition platform.

FIG. 14 is a chart associated with a first example technique for ranking workers in association with a web widget in a worker recognition platform.

FIG. 15 is a chart associated with a second example technique for ranking workers in association with a web widget in a worker recognition platform.

### DETAILED DESCRIPTION

The Figures (FIGS.) and the following description relate to various embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. The figures depict embodiments of the disclosed system (or method) for purposes of illustration only. One skilled in the art will readily recognize from the following description that alternative embodiments of the structures and methods illustrated herein may be employed without departing from the principles described herein.

A distributed online worker recognition platform connects workers of an enterprise and customers, and provides a rating system for enabling workers to receive recognition for customer service. A web widget associated with the worker recognition platform is embeddable on a third-party website to facilitate acquisition of ratings or other recognition for workers in the worker recognition platform. The web widget may display a set of avatars associated with workers that are selected and displayed based on a ranking algorithm. The ranking algorithm may be based on historical ratings received for different workers and/or may be customized to the user accessing the website to select workers most likely to have recent interactions with the user.

### Worker Recognition Platform Overview

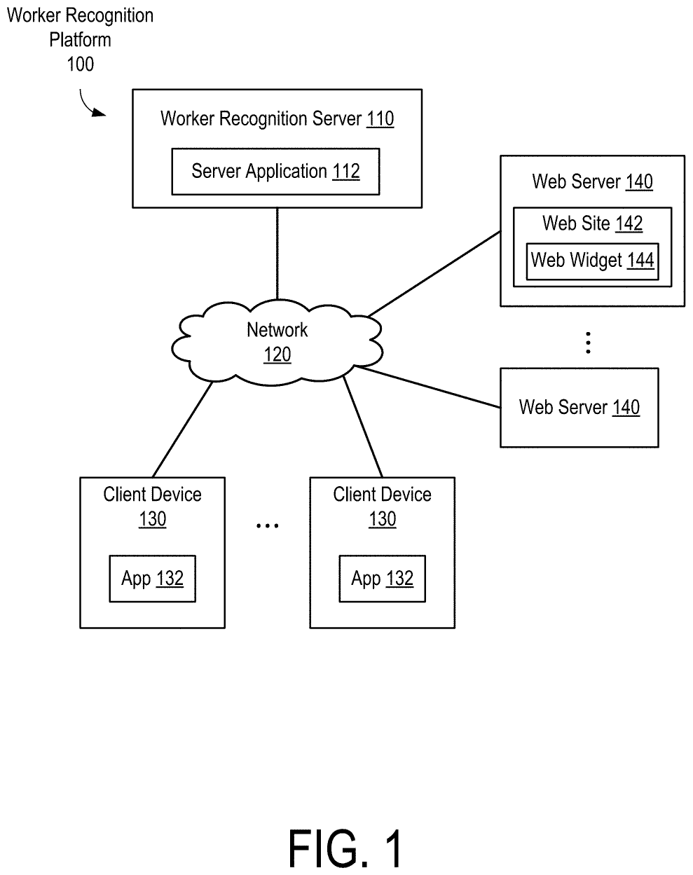

FIG. 1 is an example embodiment of a worker recognition platform 100. The platform 100 includes a worker recognition server 110, one or more web servers 140, and one or more client devices 130 coupled by a network 120. In alternative embodiments, the worker recognition platform 100 may include different or additional components.

The worker recognition server 110 facilitates various functions associated with obtaining various feedback (e.g., ratings, ranking, reviews, etc.) for workers (e.g., employees, contractors, or volunteers) of an enterprise (such as a business, non-profit organization, or other entity), performing various analytics associated with the ratings or other feedback, and generating outputs associated with the feedback that is useful to customers, businesses, workers, or other enterprises. The worker recognition server 110 may include a web server for hosting one or more web sites and/or web applications accessible by a browser of a client device 130, one or more application servers for interoperating with a native application of one or more client devices 130, and various backend processing and/or storage devices for facilitating various functions of the worker recognition server 110 described herein. The worker recognition server 110 may further execute a server application 112 for facilitating functions of the worker recognition server 110.

In an embodiment, the worker recognition server 110 obtains and stores profiles for various users, which may include customers, workers (employees or contractors) of a business, managers of a business, or other individuals. The profiles may include various identifying information for users, characteristics of the users, and/or feedback given or received by those users. The user profiles may be arranged in indexed directories that are searchable. For example, the worker recognition server 110 may maintain directories of workers and managers associated with a respective business. Profiles may be linked via connections (i.e., stored associations) in a social networking graph. For example, workers of the same business may be linked or users may establish links by providing or receiving feedback from users.

The worker recognition server 110 obtains and stores ratings that are received by users (e.g., customers) in association with other users (e.g., a worker). The ratings may be received via a client device 130 in various ways as described in further detail below. The ratings are generally intended to record and recognize service provided by the worker to the customer. For example, following an interaction with a worker associated with a particular business establishment, the customer may access the mobile application 130, search a directory associated with the business to locate the profile of the worker, and providing a rating (e.g., a rating on a scale of 1-4 or 1-5) indicative of the customer's experience with that worker. These ratings are stored to the worker recognition server 110 and may be aggregated in various ways, and/or viewed by other users.

Ratings and comments submitted through to the worker recognition server 110 may be automatically posted to a publicly available site that aggregates ratings and reviews associated with specific enterprises and their workers. For example, in one embodiment, the worker recognition server 110 may host a web site for each enterprise and for each individual worker. The web site for the individual workers may post ratings attributed to that individual. The web site for the enterprise may show a collection of reviews for various workers of that enterprise and may provide links to the pages for the individual workers.

The worker recognition server 110 may further facilitate other actions via a client device 130 in association with the customer's experience relating to a particular worker. For example, the worker recognition server 110 may facilitate interactions such as leaving a tip, providing written feedback reflecting the customer's experience, or viewing the worker's profile information.

The worker recognition server 110 may also create and maintains connections in a social graph between the users providing and receiving ratings. Once connected, rights are established to enable the users to view information in each other's profile such as ratings received or given, information posted to a feed associated with the user's profile, or other information. In an embodiment, the worker recognition server 110 furthermore aggregates ratings for a user received from multiple different users to generate an overall rating (e.g., an average, weighted average, or other combined rating) for the user that may be visible to other users having access to the profile. Ratings may also be aggregated (e.g., averaged) across multiple users (e.g., workers) associated with a particular enterprise to generate a general rating for the enterprise, that may be visible to other users. Furthermore, the worker recognition server 110 may provide notifications (e.g., via email or other messaging system) to a worker or to a manager of the enterprise upon a worker receiving a rating. A management dashboard hosted by the worker recognition server 110 enables a manager of the enterprise to access real-time data associated with its workers to track performance and memorialize customer relationships.

The worker recognition server 110 may be accessed from a client device 130 via a web site hosted by the worker recognition server 110 and/or via a mobile application hosted by the worker recognition server 110. In various embodiments, a customer may access a worker page of the worker recognition server 110 by entering a web address (e.g., URL) uniquely associated with the worker, by scanning a code (e.g., a QR code) uniquely associated with the worker, by interacting with a portion of an embedded web widget 144 uniquely associated with the worker (which may be hosted on a web server 140 external to the worker recognition server 110), or by searching the directory and selecting the worker via a website or mobile application hosted by the worker recognition server 110. The worker recognition server 110 may furthermore enable users to access an enterprise landing page (with information about a business entity or other organization), and access a directory of individual workers associated with the business entity via the enterprise landing page.

The worker recognition server 110 may be implemented via the server application 112 which comprises a set of modules stored to a non-transitory computer-readable storage medium that are executed by one or more processors. The worker recognition server 110 may comprise a single physical server, one or more virtual machines, or a distributed server (e.g., using one or more virtual machines) distributed across multiple physical servers. The modules each comprise instructions that when executed by the one or more processors, cause the one or more processors to carry out the functions attributed to the modules as described herein.

The web servers 140 each host one or more websites 142 and/or mobile applications accessible to the client devices 130 via the network 120. Websites 142 may be embodied as source code that is provided to the browser of the client device 130 upon the client device 130 accessing the web server 140. The source code includes instructions interpretable by the browser of the client device 130 for rendering the website at the client device 130. The different web servers 140 may be controlled by different enterprises (e.g., business entities or other organizations) and may each include a web site tailored to the respective enterprise. The web servers 140 and their associated web sites 142 may be owned and managed independently of the worker recognition server 110.

A website 142 hosted by a web server 140 may include, via the source code, an embeddable widget 144 associated with the worker recognition server 110. The web widget 144 comprises embeddable code that is executable by a web browser of a client device 130 for facilitating interaction with the worker recognition server 110. Alternatively, the web widget 144 may comprise a component of a native mobile application hosted by a web server 140. Upon accessing the web server 140, the client device 130 loads the web widget 144 and executes the code to facilitate various interactions with the worker recognition server 110 (e.g., via an API or other interface of the worker recognition server 110). For example, the web widget 144 may enable access to various information from the worker recognition server 110 such as worker profile information (e.g., from an employer database), ratings received, connection information, customer interaction information, or any other data described herein. The presentation and interactive behavior of the web widget 144 may be tailored to a specific user accessing the web widget 144. For example, customization of the web widget 144 may based on the user's historical interactions with the worker recognition server 110 and/or the web server 140, based on location information of the user, based on preferences of the user, or other information.

The embeddable code associated with the web widget 144 may be generated automatically by the worker recognition server 110 to enable an enterprise to easily embed the web widget 144 in their website 142. Use of such a web widget 144 beneficially enables the enterprise to provide public access and interactions with information associated with the enterprise and its workers in the worker recognition server 110 without visitors necessarily directly engaging with the worker recognition server 110.

The client device 130 comprises a computer device capable of accessing and interacting with the worker recognition server 110 and/or the web server 140. The client device 130 may include various input devices (such as a touchscreen, keyboard, mouse, joystick, microphone, camera, etc.) for receiving various inputs associated with interactions with the applications hosted by the worker recognition server 110 and/or web server 140 and one more output devices (such as a display, speaker, haptic device, etc.) for generating outputs to the user based on those interactions. In various embodiments, client devices 130 may include, for example, a mobile device, tablet, laptop computer, desktop computer, game console, or other device capable of carrying out the functions described herein.

The client device 130 executes a client application 132 such as a web-based application accessible via a browser or a native application (e.g., an iOS or ANDROID mobile application) that facilitates various functions relating to the worker recognition platform 100 described herein. The application 132 may interact with the worker recognition server 110 via an application programming interface (API) (e.g., a Node.js interface). The client application 132 may be implemented as a set of modules stored to a non-transitory computer-readable storage medium of the client device 130 that are executed by one or more processors of the client device 130. The modules each comprise instructions that when executed by the one or more processors, cause the one or more processors to carry out the functions attributed to the modules as described herein. In an embodiment, the client application 132 may be integrated with a smart voice assistant (e.g., AMAZON ALEXA) to enable interactions via voice commands and voice assistant responses.

In an embodiment, a user of the client device 130 may log into the application 132 (e.g., by providing login credentials) to enable the worker recognition server 110 to identify the user and provide a tailored experience to that user. Different types of users may have different user rights associated with the worker recognition platform 100 that control what information the user can access or edit. For example, users acting as customers may have different rights than users acting as workers, while users acting as managers or administrators may have different rights than customers or workers. Furthermore, access rights may depend in part on connections in the social graph and on various privacy settings set by different users.

In an embodiment, the application 132 may enable users to access the worker recognition server 110 in an anonymous mode without necessarily being authenticated or identified by the worker recognition server 110. Here, the user may receive only minimal rights to view information and access various functions. For example, in the anonymous mode, a user may access functions such as viewing a list of the nearby enterprises (e.g., within a threshold geographic distance), viewing a general rating for the enterprise, searching for an enterprise based on the name, viewing an overview of the enterprise's current associated workers and ratings associated with the workers, and viewing an overview of the enterprise's general rating.

Upon logging into the client application 132 (using valid login credentials), a user may access additional information. For example, the user may access a user-customized feed (e.g., ordered by date) that shows ratings received or provided by the user and/or connections of the user in the social graph and posts created by the user and/or the user's connections. The user may also access profile information for other users such as their overall rating (which may be an aggregation of individual ratings received for the user), individual ratings received, posts made by the other user, connections of the user, a resume associated with the other user, etc. The user may also view and/or edit their own personal profile including information relating to their personal feed (created posts, ratings received, ratings given, etc.), social connections, a resume, an enterprise associated with the user, etc. Users that have manager profiles may have access to additional information such as a list of enterprises under management, and various profile fields associated with the enterprises. The manager may furthermore access a list of ratings received by all workers associated with the enterprise which may be sorted by rating time or other sorting criteria. The manager may furthermore access various analytics associated with the enterprise, which may include various aggregations of worker ratings.

The network 120 may include any combination of local area and/or wide area networks, using both wired and/or wireless communication systems. In one embodiment, the network 120 uses standard communications technologies and/or protocols. In some embodiments, all or some of the communication links of the network 120 may be encrypted using any suitable technique.

Various components of the worker recognition platform 100 can each include one or more processors and a non-transitory computer-readable storage medium storing instructions therein that executed cause the one or more processors to carry out the functions attributed to the respective components described herein. The servers 110, 140 may be implemented using processing and/or storage devices that are co-located or physically remote. For example, components may be implemented using on-site storage associated with an enterprise and processing and/or cloud-based systems (e.g., public, private or hybrid public-private clouds).

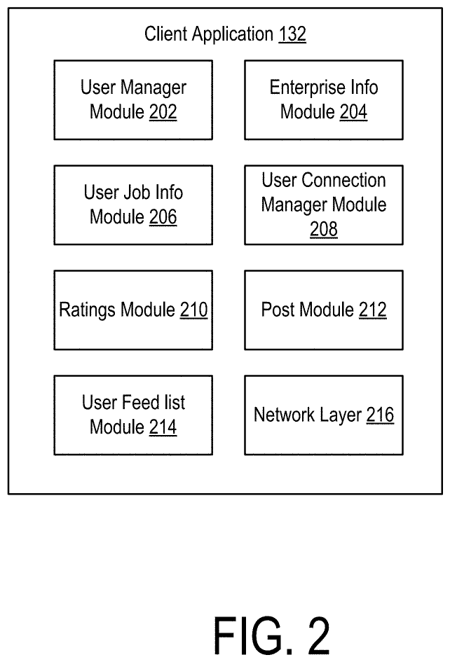

FIG. 2 illustrates a block diagram of an example embodiment of a client application 132 associated with a worker recognition platform 100. The client application 312 includes a user manager module 202, a business information module 204, a user job information module 206, a user connection manager module 208, a ratings module 210, a post module 212, a user feed list module 214, and a network layer 216. In other embodiments, the client application 132 may include different or additional modules.

The user manager module 202 facilitates various functions associated with managing users of the worker recognition platform 100. For example, the user manager module 202 may present user-related information to a display of the client device 130 via a user interface and may facilitate interactions between users. For example, the user manager module 202 may facilitate viewing, creating, and interacting with a user feed list (which includes descriptions of historical interactions of the user such as rating given or received), posts, given and received ratings, connections made, or other activities. The user manager module 202 may further enable the user to view or interact with job related information such as the user's current working jobs and full resume information.

The enterprise information module 204 facilitates various functions for managing enterprise information relating to the worker recognition platform 100. The enterprise information module 204 may present a list of business or other organizations that are located near the user (e.g., using a directory and/or maps services) when the user accesses the client application 132. The enterprise information module 204 may also facilitate a search capability to enable a user to search for an enterprise via a query in the user interface. The available enterprise information may include information about the enterprise itself and list of workers associated with the enterprise. The list may optionally identify workers that are presently working.

The user job information module 206 facilitates creation and management of connections between enterprises and users. For example, the user job information module may present a list of workers associated with each enterprise. A manager may create, edit, and/or view these connections in association with a managed enterprise via this module 206.

The user connection manager module 208 facilitates management of connections between different users of the worker recognition platform 100. For example, the user connection manager module 208 may enable viewing of data associated with a social graph representing different types of stored connections.

The ratings module 210 manages ratings associated with workers of the worker recognition platform 100. For example, the ratings module 210 enables a user to submit a rating for a worker, view ratings given or received, or view various aggregations of ratings.

The post module 212 facilitates management of posts by user in the worker recognition platform 100. For example, the post module 212 enables creation, editing, and/or sharing of posts that may appear on a user's feed and that may be accessible to connected users. Posts may include ratings given or received, comments, images, or other media content.

The user feed list module 214 generates the user feeds that may be customized for each user.

The network layer module 216 internally communicates with the other modules of the client application 132 to facilitate network communications with the worker recognition server 110.

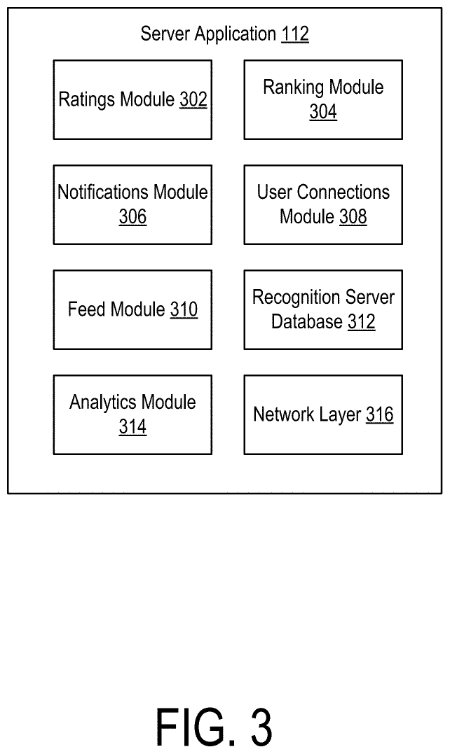

FIG. 3 illustrates an example embodiment of a worker recognition server application 112 that may interact with the client application 132 to facilitate functions described herein. In an embodiment, the server application 112 comprises a ratings module 302, a ranking module 304, a notifications module 306, a user connection module 308, a feed module 310, a recognition server database 312, an analytics module 314, and a network layer 316. In alternative embodiments, the server application 112 may include different or additional modules.

The ratings module 302 obtains new ratings from the client applications 130 and computes or updates a general rating for the user being rated and a general rating for the enterprise associated with the user. The ratings module 302 may store the updated user and enterprise ratings (or various aggregations or analytics thereof) to the recognition server database 312.

The ranking module 304 computes and tracks a score for each individual worker in the worker recognition platform 100 based on collective ratings or other feedback received for that worker. The ranking module 304 may rank workers according to various sorting mechanisms. These rankings may be used for various functions, such as controlling how information about workers are presented in response to interactions with the web widget 144 or when accessing directories of the server recognition server 110.

The notifications module 306 may send electronic notifications to client devices 130 of users in response to a trigger event. Notifications may be sent via email, text, phone call, push messages, web-based messages, or other communication mechanisms. Trigger events may include, for example, the user receiving a new rating, a profile of a user or enterprise changing, new connection request, or other events. In an embodiments, notifications may be customized for individual users based on configurable user preferences.

The user connections module 308 receives notifications when a new rating for a user is received and automatically generates a connection in a social network graph linking the user providing the rating and the user receiving the rating. Additionally, the user connections module 308 may create or disable connections based on specific requests from users via the client application 130. The user connections module 308 may store updated connection information to the recognition server database 312 responsive to changes in connections.

The feed module 310 generates the user feeds for different users based on relevant information in the database 312. For example, the feed module 310 generates an entry in the feed responsive to a new user connection being made, in response to receiving or sending a new rating, in response to a post by the user or a user's connection, or in response to other events of relevance to the user. Users may configure their respective feeds to control if certain types of posts are visible or hidden in their feed.

The recognition server database 312 stores various information relating to functions of the worker recognition platform 100 described herein. For example, the recognition server database 312 may store user profile information for users, enterprise profiles, ratings, aggregations of ratings, connections between users, posts, various analytical data, or other information associated with operation of the worker recognition platform 100.

The analytics module 314 generates various analytics relating to ratings or other information stored to the recognition server database 312. In an embodiment, the analytics module 314 may include an artificial intelligence engine that generated various inferences based on received ratings, text-based feedback, tips received, profile information, posts, connection, or a combination thereof. The artificial intelligence engine may perform natural language processing and sentiment analysis of text-based feedback to generate metrics associated with the responses and combine this information with numerical ratings to generate advanced rating scores. The analytics module 314 may furthermore generate various recommendations such as recommending a user to rate or to connect with.

The network layer 316 facilitates communications between the server application 112 and the client application 132 via the network 120.

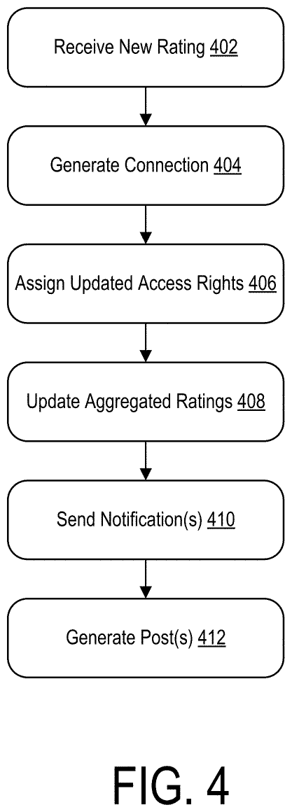

FIG. 4 illustrates an example embodiment of a process for managing a rating in the worker recognition platform 100. The worker recognition server 110 receives 402 a rating for worker and receives identifiers for the user creating the rating and the worker receiving the rating. Upon receiving the rating, the worker recognition server 110 generates 404 connection information indicating a connection in a social graph between the user providing the rating and the user receiving the rating. Upon establishing that connection, each of the two users are assigned 406 updated rights to enable the users to access information about the other user. For example, users may be able to view posts, ratings given, ratings received, or other profile information relating to connected users and this information may appear in the user's feed. In an embodiment, connections are created between two users only when a rating is provided for one user by the other user (and only if a connection was not created before). In an embodiment, connections are persistent and cannot be deleted from the underlying social graph by the users. Instead of deleting the underlying connection, if at least one of the two users involved in a connection does not want to see or to be seen by the other user, the user can opt to disable the connection and remove rights from both users that were established in association with the connection (e.g., rights to view each other's private profile information, feed data, rating data, etc.). This is achieved by marking the connection as broken via the user interface. In this implementation, a broken connection can be re-activated only by the user that marked the connection as broken. By implementing this approach, the worker recognition platform 100 can provide a mechanism to stop potential harassment (if needed by any user) and to generate a layer of privacy. Received ratings and connections may be stored to the database 312.

Upon receiving a rating, the worker recognition server 110 may furthermore update 408 aggregated ratings associated with the user receiving the rating and the enterprise associated with the user. Aggregating the ratings may be performed in a manner that mitigates fraudulent attempts to artificially improve ratings. In this implementation, a user can rate another user (worker) only if the user's account was validated previously (e.g., users in anonymous mode cannot provide ratings). The rating algorithm for computing the user and business general ratings operates to ensure that malicious users cannot substantially manipulate the ratings by providing a large number of misleading rating submissions. To achieve this, the algorithm marks the latest rating submitted by a specific user as active. All active ratings for a worker are combined (e.g., averaged) to generate a general rating. Non-active ratings do not contribute to the general rating. Thus, if the same user submits multiple ratings for the same worker, only the most recent rating (determined based on date and timestamp) contributes to the general rating. In an embodiment, a general rating for an enterprise is similarly generated by averaging all active ratings for workers of the enterprise. Thus, if single user provides multiple ratings for the same worker of the enterprise, only the latest rating contributes to the general rating for the enterprise.

The worker recognition platform may also send 410 a notification to the user receiving the rating and/or the user's manager to notify the user of the newly received rating. The worker recognition server 110 may also generate 412 a new post in the respective feeds of the users sending and receiving the rating indicative of the rating. In an embodiment, all of the user's connections can see the new rating post in the user's feed (unless marked as hidden). a rating is created.

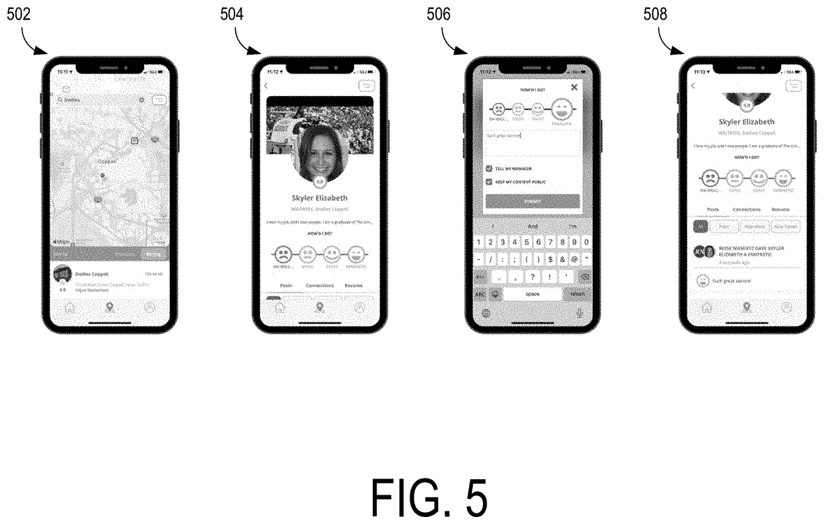

FIG. 5 illustrates an example set of user interface screens associated with the client application 132 that represent an example user experience associated with rating a worker. The user interface presents a search screen 502 that enables a user to search for and select a local enterprise. In an embodiment, the search screen 502 may display a map (accessed from a maps service provider) that shows the user's location and nearby enterprises. Enterprises may be automatically recommended to a user based on the location (e.g., if it is detected that the user is on the premises of a particular business). The search screen 502 may additionally include a text-based search box to enable the user to search for a particular location or enterprise. The search screen 502 also lists one or more selectable enterprises corresponding to geographic area in the map.

After selecting an enterprise on the search screen 502, the user can browse a directory of workers associated with the enterprise and select a particular worker (e.g., after having an in-person interaction with that worker). The user interface may present a public profile screen 504 associated with the worker, which may include, for example, a profile photo, a name, a job description, a profile statement, and a general rating. The profile page may furthermore include posts from the worker, other connections associated with the worker, and a resume for the worker if visible. The profile screen 504 may include a rating control element that enables the user to select to leave at a rating for the worker. Selection of the rating element may trigger a rating screen 506 for rating the worker. For example, in the illustrated embodiment, the user can select ratings from “oh well,” “good,” “great,” or “fantastic” (which may correspond to numerical ratings on a scale of 0-3 or 1-4). In alternative embodiments, the user may instead provide a numerical rating, a star rating, or other type of rating. The rating screen 506 may also enable the user to leave text-based feedback. In an embodiment, the rating screen 506 furthermore presents options to let the user decide whether or not to share the feedback with the worker's manager and/or whether to make the feedback public. The rating screen 506 may furthermore provide an option to enable the user to leave a tip for the worker which may be processed through an electronic payment system. After selecting to submit the rating, the application 132 may return to the profile screen 508, which now includes the rating on the worker's feed.

In an embodiment (not shown in FIG. 5), the user may be presented with a link after leaving a rating and/or comment that prompts the user to leave a review on an external review site associated with the employer. For example, the user may be prompted to leave a review for the business on sites such as TRIPADVSOR, YELP, GOOGLE, FACEBOOK, LINKEDIN, or other sites that enable reviews of businesses. Here, in response to selecting the link, the client application 132 may automatically access a review submission page associated with the external site and may prepopulate various input fields based on the information the user already provided in the worker recognition platform 100. For example, the client application 132 may prepopulate a rating and comments box. Here, the information may be modified (with the user's permission) to better tailor the review for the external site. For example, the comments associated with a specific worker in the work recognition platform 100 may be updated to include the name of the worker in the submission to the external review site for reviewing the enterprise. Furthermore, text inputs may be automatically shortened to meet character limits of the external site.

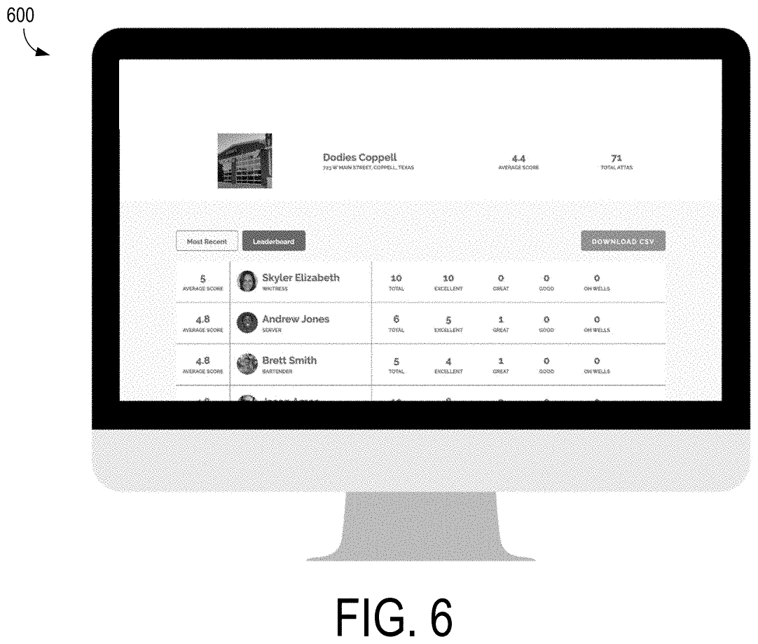

FIG. 6 illustrates an example embodiment of a user interface dashboard 600 that may be available to a manager of an enterprise via the client application 132. Here, the dashboard 600 may present a list of workers associated with the enterprise, their general rating, total number of ratings received, and a histogram of different ratings. The dashboard 600 may enable sorting of workers based on various criteria including by general rating or by most recent reviews. The information on the dashboard 600 can furthermore be downloadable to a spreadsheet format to enable the manager to perform additional analytics. The dashboard 600 may also present a general rating for the business and the total number of ratings received.

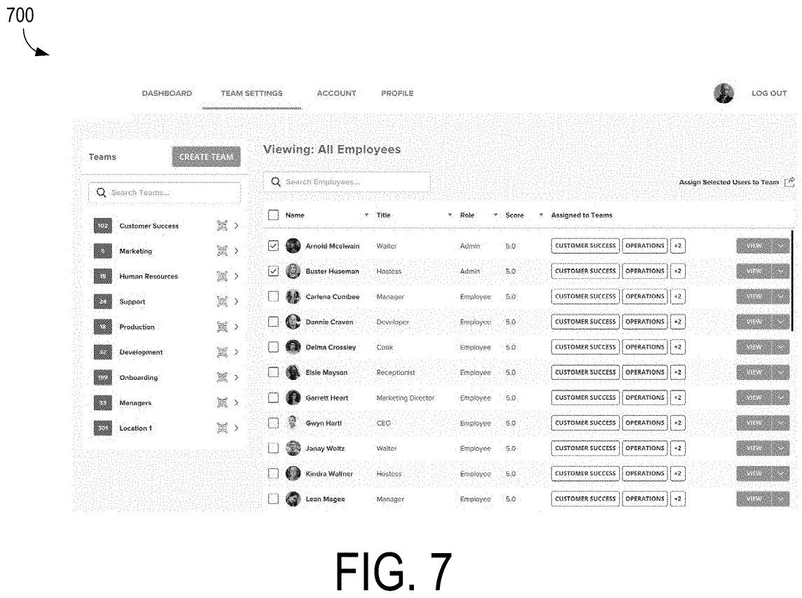

FIG. 7 illustrates another example embodiment of a manager dashboard 700 that may be available to the managers of an enterprise via the client application 132. Here, the dashboard 700 may present a list of entities, consisting of enterprise organization departments or groups of workers associated with the enterprise. The business managers (which include users of the system with proper access level), can manage (e.g., create, edit, delete) the characteristics of the grouping entities. Grouping entities may have a set of associated parameters including, for example, an identification name, a list of users with higher access level (these levels can be account owner level, super admin level and Admin level), and a list of worker users (e.g., employee level) that are members of the grouping entity. The membership relation of the users (any access level) with the grouping entity, can be a many-to-many relationship. Users can be member of multiple grouping entities at the same time. The grouping entities may be specific to different enterprises such that each enterprise has its own independent set of grouping entities. At the data layer level, groups are sub-parts of an enterprise.

The dashboard 700 may present a list of workers associated with the enterprise, their general rating score, their role level, and their membership of grouping entities. For users with proper access levels, the dashboard 700 may enable various interactions such as assigning (individually or in bulk) workers to grouping entities, granting access levels to users, searching and/or sorting the worker list and the grouping entities list, and filtering users by group membership.

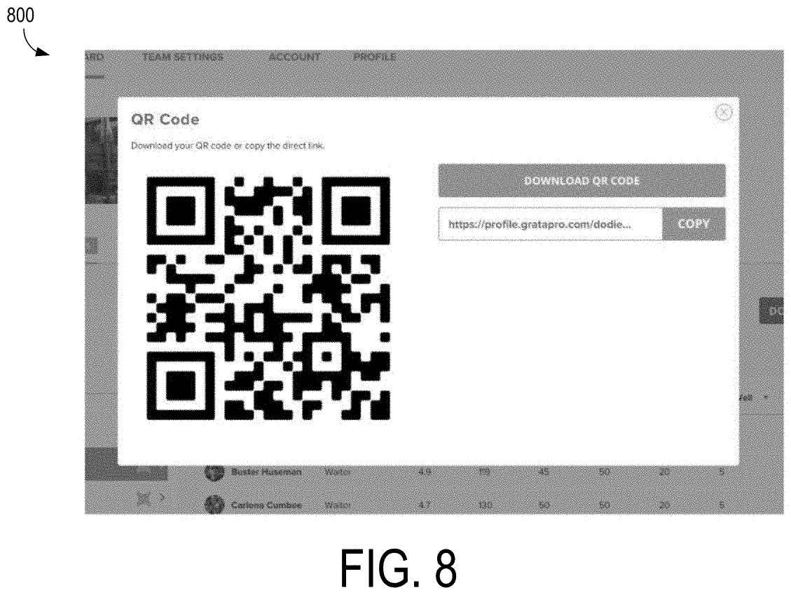

FIG. 8 illustrates an example of a QR (Quick Response) code interface 800 that presents a scannable code for reading by an imaging device such as a camera of the client device 130. The pattern in the QR code references a web address (e.g., URL) or web resource that provides access to various functions of the worker recognition platform 100 described herein. The scannable code may be automatically generated by the worker recognition server 110 via an administrative portal accessible to managers of an enterprise. The scannable code may enable access to a profile page in the server recognition server 110 associated with an individual worker, a grouping entity, or an enterprise, a website associated with the enterprise (e.g., hosted by a web server 140), or a rating page associated with the enterprise or individual worker.

Business managers that have proper access level can download the scannable code and share it in public places (e.g., on printed paper or signs within a business establishment). Customers may then scan the code to access the web resources associated with the employee, group, or business and provide ratings or feedback. In alternative embodiments, a different type of scannable code (e.g., a bar code) may be used for similar purposes that is not necessarily a QR-style code.

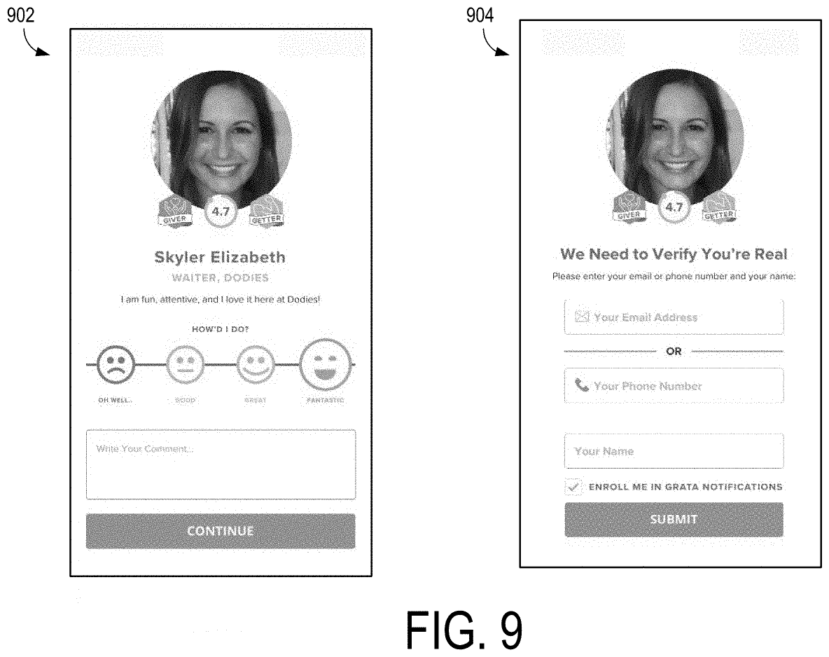

FIG. 9 illustrates example interface screens 902, 904 that may be accessed responsive to scanning an example scannable code. In an embodiment, the client application 132 may process the scannable code differently depending on whether or not a native mobile application associated with the worker recognition platform 100 is installed. If a native application is installed, then an application extension may digest the information from the scannable code and cause the client application 132 to access appropriate resources through the native mobile application. For example, the user may be directed to an appropriate interface screen 902 of the application for providing a rating and leaving feedback as described above.

If a native application associated with the worker recognition platform 100 is not installed, the scannable code instead operates to access a webpage (including an interface screen 902 for providing ratings and/or other feedback) of the worker recognition server 110 via a browser application. Here, because the user's identity may be anonymous (since it is not verified through the mobile application), a verification may be employed to identify the individual prior to receiving the rating. For example, the identification step may involve presenting a verification interface screen 904 including a web form requesting an email address or phone number to which a unique identification code is sent using available third-party service providers. The user's identity can then be tracked to safeguard against malicious activity (such as attempting to skew a rating for an employee through repeat submissions).

### Web Widget for a Worker Recognition Platform

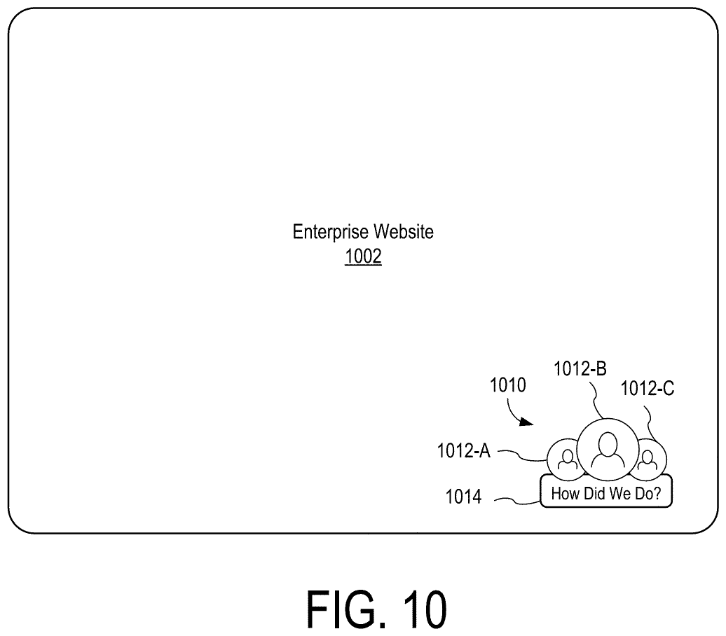

FIGS. 10-15 describe operation of a web widget 144 comprising a set of code that can be embedded on a web page of a web site 142 and executable by a browser upon loading the web page. Alternatively, the web widget 144 may be embedded in a mobile application. The web widget 144 provides another entry point into the worker recognition platform 100 and may present a seamless and publicly accessible mechanism for gathering worker feedback.

To deploy the web widget 144, an enterprise may copy the widget code (which may be generated by the worker recognition server 110) and embed the code in its website 142. For example, the web widget 144 may comprise a javascript code snippet embeddable in the web properties header code. The embeddable code for the web widget 144 may include a field for the business to provide a business identifier that links the web widget 144 to the enterprise's information in the worker recognition server 110 including the worker directory information and rating information. Upon loading, the web widget 144 can interact with the worker recognition server 110 to access information about the enterprise and its workers.

FIG. 10 illustrates an example embodiment of a closed view of a web widget 1010 overlaid on an enterprise website 1002. The web widget 1010 may be appear in this closed view when the website 1002 is initially loaded. In this embodiment, the web widget 1010 displays a set of three avatars 1012-A, 1012-B, 1012-C each associated with a different worker of the enterprise. The avatars 1012 may display respective profile pictures (e.g., faces) of the three different workers that may be obtained from their respective profiles in the worker recognition server 110. The avatars 1012 may rotate over time (e.g., based on fixed intervals) in an animated fashion as will be further described below. For example, in an embodiment, the web widget 1010 may rotate between avatars 1012 for six different workers, displaying three faces at a time.

Each of the avatars 1012 may comprise a selectable hot spot that can be accessed when the user interacts with the area of the interface associated with the avatar 1012 (e.g., using a mouse or touchscreen). The web widget 1010 may additionally include a general interaction banner 1014 (e.g., displaying “How Did We Do?” or other custom content) that is also interactive. In alternative embodiments, the web widget 1010 may display a different number of avatars 1012 at a time, may rotate through different numbers of avatars 1012, and may arrange the avatars 1012 differently.

In an embodiment, the web widget 1010 dynamically and intelligently selects workers for including in the avatars 1012 in a manner that encourages customer engagement. Example techniques for selecting workers for display in the web widget 1010 are described in further detail below.

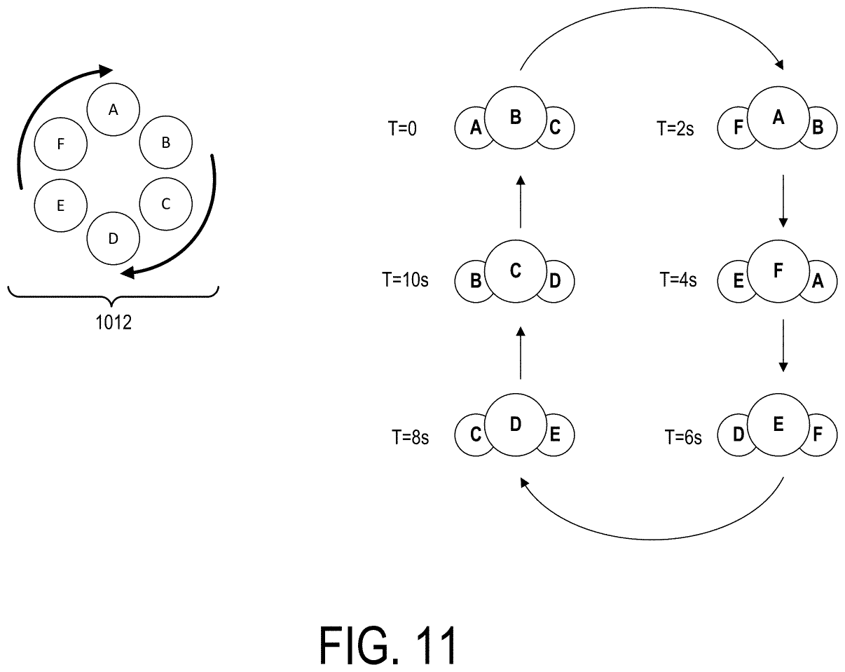

FIG. 11 illustrates an example scheme for animating the display of avatars 1012 in a closed view of a web widget 1010. Here, six avatars 1012 are rotated every two seconds, with three avatars 1012 being shown at any given time. For example, a set of avatars 1012 (labeled A-F) are rotated as shown. In this rotation scheme, the avatars 1012 rotate in a clockwise direction between six avatar slots (one per timestep), of which three are visible and the remaining three are hidden. In alternative embodiments, the rotation scheme may involve more or fewer avatar slots, more or fewer visible slots, rotations in a different direction, rotations of different number of avatars per timeslot, or different length time slots.

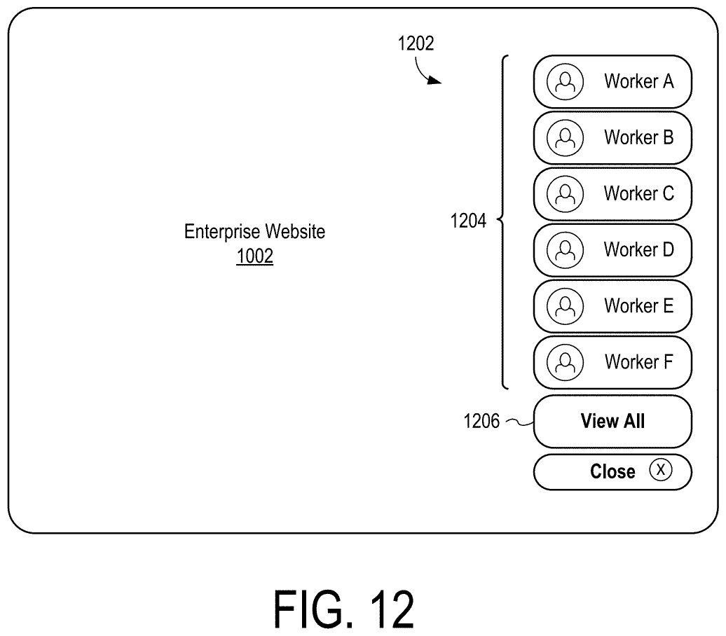

FIG. 12 illustrates a fanout interface 1202 of a web widget 144 that may appear when a user selects one of the selectable areas of the closed view of the web widget 1010 (e.g., an avatar 1012 or the general interaction banner 1014). The fanout interface 1202 includes a set of selectable cards 1204 each associated with a different worker of the enterprise. The cards 1204 may display the worker's profile picture, name, position, and/or other identifying information. Selection of a card 1204 for a specific worker causes a rating interface screen for that worker to be displayed to enable the user to provide a user rating or other feedback. The fanout interface 1202 may also include a View All button 1206 that may link to a directory screen associated with the enterprise providing a directory of workers. The directory screen may include a directory view that includes a grid of icons operating as links to the individual rating pages for different workers. The icons may comprise, for example, profile pictures and/or other identifying information for the workers. In an embodiment, the directory screen may further enable text-based searching and/or filtering by specified criteria to locate individual workers. The fanout interface 1202 may also include a close button 1208 that when selected, closes the fanout interface 1202 and returns to the closed view of the web widget 1010.

In an embodiment, a visual indicator may indicate a card 1204 associated with the avatar 1012 that was selected in the closed view of the web widget 1010. For example, the card 1204 may be highlighted, animated, shown larger, or otherwise visually emphasized to direct the user to the specific worker that they clicked on in the closed view of the web widget 1010. If the user accessed the fanout interface 1202 from the general interaction banner 1014 (without selecting a specific avatar 1012), the cards 1204 in the fanout interface 1202 may instead be shown without visually emphasizing any particular card 1204.

In an embodiment, if the user clicks the close button 1208, after accessing the fanout interface 1202, the closed view of the web widget 1010 is subsequently shown with only the general interaction banner 1014 and without displaying any avatars 1012 or animations.

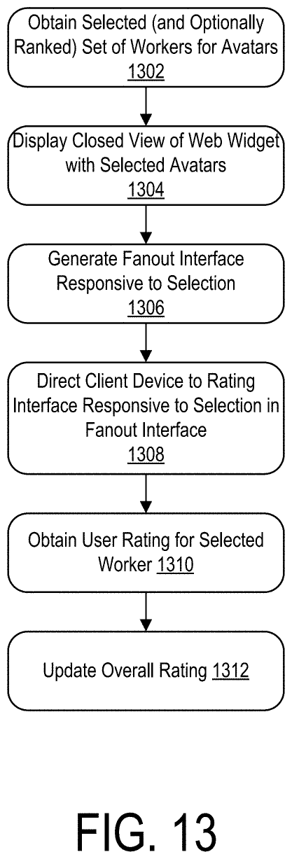

FIG. 13 is a flowchart illustrating an example embodiment of a process for operating a web widget 144 associated with a worker recognition platform 100. Upon loading the web widget 144, the client application 132 may interact with the worker recognition server 110 to obtain 1302 a selected set of workers for displaying in the avatars 1012 the closed view of the web widget 1010 that will be overlaid on the website 1002. The worker recognition server 110 may select the workers in various ways. The worker recognition server 110 may dynamically rank workers (by generating ranking values for each worker) and select workers having the highest ranking values. Here, the ranking values may be generated based in part on respective cumulative ratings, a number of recently received ratings, a subset of most recent ratings, a time period since one or more most recently received ratings, a current location the employee (e.g., whether or not the employee is currently at work), or other factors. Selection of workers may also be made based in part on rating histories for the workers. For example, the worker recognition server 110 may select the workers with highest overall ratings and rank the workers directly based on overall ratings. Alternatively, the worker recognition server 110 may select and rank the workers for including in the web widget 1010 based in part on recency of prior ratings. In further embodiments, a random component may affect selection of workers.

In an embodiment, the ranking values may be generated based on predicted likelihoods of the user wanting to provide a rating or other feedback to particular workers. Here, the selection and/or ranking of worker may be customized to the individual viewing the website. For example, a web cookie may be obtained from the client application 132 to identify the user accessing the web site, and workers may be selected and ranked in a manner customized to the viewing user. a web cookie may be used to identify the individual viewing the website 1002. The worker recognition server 110 may infer which workers have highest estimated likelihoods of recent in-person interactions with the user and select those workers for display. This inference may be made based on location information associated with the viewing user (e.g., based on current location information or check-ins with the enterprise, stored connections of the user), based on worker schedules or location tracking, based on express customer service data shared from the enterprise relating to customer service assignments, or other predictive data.

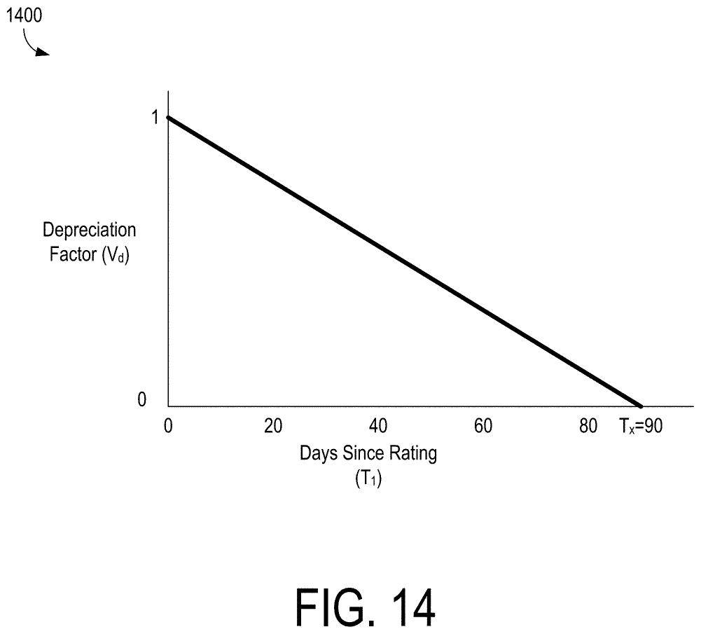

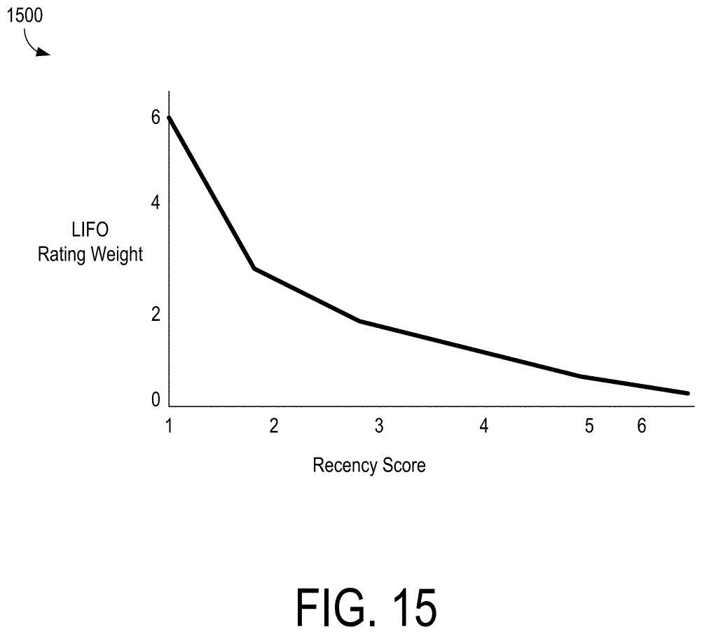

The ranking values used for avatar selection may furthermore be based on various to algorithmic methods. These methods may include but are not limited to, depreciation stacking, last in first out, geography-based check-ins, manual check-ins, integrated scheduling systems, and volume-based time-boxing. Furthermore, the ranking algorithm may compute a score or ranking for weighting scores derived from a combination of different methods or selecting which method is most appropriate in a given situation. Further examples of techniques for selecting and ranking workers are described below with respect to FIGS. 14-15.

Upon selecting the workers for display, the web widget displays 1304 the closed view of the web widget 1010 using avatars 1012 for the selected workers. The selected avatars 1012 may optionally be animated in the manner described above. In some embodiments, only a subset of the selected avatars 1012 may be visible in each time period as the avatars 1012 are rotated (e.g., rotating through a set of six avatars 1012 with three avatars 1012 visible at any time). In an embodiment, one or more top-ranked avatars 1012 may be highlighted in the rotating set of avatars 1012 in the web widget 1010, for example, by including a visual indicator such as a pulsating aura or animated ring around the employee's avatar image.

The web widget 144 detects selection of avatar 1012 (or the general interactive banner 1014) and generates 1306 the fanout interface 1202. If the fanout interface 1202 is accessed via selection of a specific avatar 1012, the fanout interface 1202 may optionally display the profile cards 1204 in a manner that highlights the card 1204 for the worker associated with the selected avatar 1012 (e.g., using a visual indicator).

The fanout interface 1202 may select and rank a subset of workers and order the workers (for example, from top to bottom) based on any of the ranking criteria used to rank the workers for avatar selection as describe above. For example, the fanout interface 1202 may order the workers based on the same ranking values generated when selecting avatars 1012. Alternatively, different ranking criteria may be used in this view.

The web widget 144 detects selection of a card 1204 in the fanout interface 1202 and directs 1308 the client device 130 to a rating screen in response to the selection. Here, if the user selects a card 1204 for a specific worker, the web widget 144 may direct the client directly to the rating page for that worker. Alternatively, if the user selects a View All button 1206, the web widget 144 may direct the client device 130 to a directory view (e.g., a grid of icons) associated with the enterprise. The workers in the directory view may be ordered based on any of the ranking criteria used to rank the workers for avatar selection and/or the fanout view described above. For example, the directory interface may order the workers based on the same ranking values generated when selecting avatars. Alternatively, different ranking criteria may be used in this view.

The directory view and/or fanout views may also provide links to enable the user to access the individual employee pages hosted by the worker recognition server 110 as described above. The worker recognition server 110 then obtains 1310 the ratings. Upon receiving selection of a rating, the rating may be stored and/or aggregated with other ratings to update 1312 the overall rating as described above. In an embodiment, the user may furthermore be presented with an option to leave a review for the worker on an external platform such as a platform associated with rating enterprises.

In an embodiment, a web widget 144 may skip display of the fanout interface 1202 when a specific avatar 1012 is selected and instead direct the client directly to a rating page for the worker associated with that avatar 1012. In other embodiments, the web widget 144 may include different or additional views.

FIG. 14 is a chart 1400 illustrative of an example technique for setting ranking values of workers based on time-depreciated ratings. The chart 1400 illustrates an example of a straight-line depreciation. Here, for each rating for a worker, the ranking value is generated by depreciating the rating over time in accordance with a depreciation factor that decreases linearly. In the illustrated example, the depreciation factor decreases linearly from 1 to 0 over a 90 day period. For example, the depreciation factor V_{d} may be given by V_{d}=1−T₁/Tₓ, where T₁ is the number of days since the rating was received and Tₓ is the number of days before the depreciation factor reaches zero. Ranking values for each worker may be generated as a weighted combination of each rating weighted by their respective depreciation values.

FIG. 15 is a chart 1500 illustrating another example technique for setting ranking values of workers using a last-in-first-out (LIFO) technique. Here, a stacked ranking of the last N workers to receive a rating (e.g., N=6 in this example) may be ranked as follows:

IF E_{N}>N THEN V_{L}=0

V_{L}=(N+1−E_{N})(1/E_{N})

where E_{N} represents a recency score for a worker where E_{N}=1 represents the most recently rated worker and E_{N} increases with increased time since the worker received a rating, V_{L} represents the ranking value, N represents the number of workers to track. Ranking values for each worker may be generated as a weighted combination of each rating weighted by their respective rating weights.

In another embodiment, a combination of techniques may be employed. For example, the ranking value may be generated based on a weighted combination of the depreciation factor in FIG. 14 and the rating weights in FIG. 15.

In another example embodiment, a worker's predicted or sensed location may be used to dynamically determine their ranking value. For example, a background location tracking technique may be used in which the coordinates of the worker's working location is compared with current location information (e.g., tracked via the location of their personal mobile device), to check for proximity. The worker's location may also be detected when the worker manually checks into work (e.g., via an enterprise time tracking system). In an embodiment, such check-ins may be integrated into the client application 132 of the worker recognition platform 100. For example, the worker may use the client application 132 to indicate when they are on site, confirm their location via a temporary location share to check coordinate proximity, and indicate how long their shift is or their expected time on site for a given day or check in period. In an embodiment, ranking scores for workers determined to be on-site may be significantly increased on this basis.

In further embodiments, geo-based scoring can be optimized via certain predictive variables, including the average length of a worker's shift on a given day, the average length of time for a worker to be on location, or other estimated factors. Further predictive algorithms can be used to optimize the impact of one or more of these variables on a given worker's temporary increase in ranking value.

Workers that are determined to be on site and are amongst the top-rated workers by aggregated rating may be given special emphasis visually in the web widget (e.g., in the form of a pulsating aura, animated ring, or other visual effect around their avatar and/or card). Such visual effects may be activated temporarily based on the length of time the worker is expected to be at work. In another embodiment, the visual indicator to indicate that the worker is present at the workplace may be independent of the ranking and selection process. Here, ranking and selection may be implemented as described above, and identification of on-site workers may be identified independently.

### Additional Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

The various operations of example methods described herein may be performed, at least partially, by the one or more processors that are temporarily configured (e.g., by software or program code comprised of instructions) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs)).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Upon reading this disclosure, those of skill in the art will appreciate still additional alternative structural and functional designs for a system and a process for the embodiments herein through the disclosed principles herein. Thus, while particular embodiments and applications have been illustrated and described, it is to be understood that the disclosed embodiments are not limited to the precise construction and components disclosed herein. Various apparent modifications, changes, and variations may be made in the arrangement, operation and details of the method and apparatus disclosed herein.

1. A method for operating a web widget associated with a worker recognition platform, the method comprising:
generating, for display in a client device, a closed view of the web widget as an overlay on a web page of a web site associated with an enterprise upon the client device accessing the web page, wherein the closed view of the web widget include a set of avatars representing different individual workers of the enterprise having profiles associated with the enterprise in a database of a worker recognition server;
animating the closed view of the web widget to rotate the set of avatars such that at least one of the set of avatars changes in each time period over a sequence of time periods;
detecting a selection of an avatar of the set of avatars via an input device of the client device;
responsive to the selection of the avatar, generating a fanout view of the web widget that includes a set of cards associated with the different individual workers of the enterprise, the set of cards including identifying information of the different individual workers, and the set of cards including a visual indicator identifying a card associated with a worker of the selected avatar;
detecting a selection of a card from the set of cards via the input device of the client device;
responsive to the selection of the card, directing the client device to a rating page hosted by the worker recognition server that is associated with a worker of the selected card;
obtaining, via the client device, a user rating for the worker of the selected card via the rating page;
updating an overall rating for the worker based on the user rating and historical ratings for the worker of the selected card; and
storing the overall rating to the database of the worker recognition server.

2. The method of claim 1, wherein animating the closed view of the web widget comprises:
rotating the set of avatars through a fixed set of avatar slots, wherein a first subset of the avatar slots are visible in the closed view of the web widget, and a second subset of the avatar slots are hidden in the closed view of the web widget.

3. The method of claim 1, wherein the closed view of the web widget further comprises a general interaction banner, the method further comprising:
detecting a selection of the general interaction banner via the input device of the client device; and
responsive to the selection of the general interaction banner, generating the fanout view of the web widget without the visual indicator identifying any specific card of the set of cards.

4. The method of claim 1, wherein the closed view of the web widget further comprises a general interaction banner, the method further comprising:
detecting in the fanout view of the web widget, a selection to close the fanout view of the web widget; and
responsive to the selection to close the fanout view of the web widget, generating display of a modified view of the web widget that includes the general interaction banner without showing the set of avatars.

5. The method of claim 1, wherein the fanout view of the web widget includes a view all button, the method further comprising:
responsive to detecting selection of the view all button, directing the client device to a grid view page for the enterprise hosted by the worker recognition server, the grid view page including a set of selectable icons for each of the different individual workers associated with the enterprise; and
responsive to detecting a selection of an icon for a worker, directing the client device to a rating page hosted by the worker recognition server that is associated with the worker of the selected icon from the grid view page.

6. The method of claim 1, further comprising:
publishing at least one of the user rating and the overall rating to a feed associated with the worker hosted by the worker recognition server.

7. The method of claim 1, wherein generating the display of the closed view of the web widget comprises:
selecting the set of avatars based on at least one of overall ratings of the workers of the enterprise, a subset of recent ratings for the workers of the enterprise, a time period since receiving one or more ratings for the workers of the enterprise, and current locations of the workers of the enterprise.

8. The method of claim 1, wherein generating the display of the closed view of the web widget comprises:
generating display of a visual indicator to highlight at least one of the avatars based on overall ratings for the workers associated with the avatars.

9. The method of claim 1, wherein generating the display of the closed view of the web widget comprises:
obtaining a web cookie from the client device;
obtaining user identifier data for a user accessing the web page based on the web cookie; and
selecting the set of avatars for the closed view of the web widget based at least in part on the user identifier data.

10. The method of claim 9, wherein selecting the set of avatars comprises:
inferring, based on the user identifier data, a subset of workers of the enterprise that the user having highest estimated likelihoods of recent in-person interactions with the user; and
selecting the set of avatars corresponding to the subset of the workers having the highest estimated likelihoods.

11. The method of claim 1, wherein generating the display of the closed view of the web widget comprises:
selecting the set of avatars for the closed view of the web widget based at least in part historical ratings received for the different individual workers.

12. The method of claim 11, wherein selecting the set of avatars comprises:
selecting the set of avatars corresponding to a subset of workers of the enterprise having highest overall ratings.

13. The method of claim 11, wherein selecting the set of avatars comprises:
selecting the set of avatars corresponding to a subset of workers of the enterprise having highest ranking values computed based at least in part on aggregations of respective historical ratings depreciated over time.

14. The method of claim 11, wherein selecting the set of avatars comprises:
selecting the set of avatars corresponding to a subset of workers of the enterprise having highest ranking values computed based at least in part on respective recencies of received ratings.

15. The method of claim 11, wherein selecting the set of avatars comprises:
selecting the set of avatars corresponding to a subset of workers of the enterprise having highest ranking values computed based at least in part on predicted locations of the subset of workers relative to a location associated with the enterprise.

16. A non-transitory computer-readable storage medium storing instructions for operating a web widget associated with a worker recognition platform, the instructions when executed by one or more processors causing the one or more processors to perform steps comprising:
generating, for display in a client device, a closed view of the web widget as an overlay on a web page of a web site associated with an enterprise upon the client device accessing the web page, wherein the closed view of the web widget include a set of avatars representing different individual workers of the enterprise having profiles associated with the enterprise in a database of a worker recognition server;
animating the closed view of the web widget to rotate the set of avatars such that at least one of the set of avatars changes in each time period over a sequence of time periods;
detecting a selection of an avatar of the set of avatars via an input device of the client device;
responsive to the selection of the avatar, generating a fanout view of the web widget that includes a set of cards associated with the different individual workers of the enterprise, the set of cards including identifying information of the different individual workers, and the set of cards including a visual indicator identifying a card associated with a worker of the selected avatar;
detecting a selection of a card from the set of cards via the input device of the client device;
responsive to the selection of the card, directing the client device to a rating page hosted by the worker recognition server that is associated with a worker of the selected card;
obtaining, via the client device, a user rating for the worker of the selected card via the rating page;
updating an overall rating for the worker based on the user rating and historical ratings for the worker of the selected card; and
storing the overall rating to the database of the worker recognition server.

17. The non-transitory computer-readable storage medium of claim 16, wherein animating the closed view of the web widget comprises:
rotating the set of avatars through a fixed set of avatar slots, wherein a first subset of the avatar slots are visible in the closed view of the web widget, and a second subset of the avatar slots are hidden in the closed view of the web widget.

18. A method for operating a web widget associated with a worker recognition platform, the method comprising:
accessing a database of a worker recognition server to dynamically select a subset of workers associated with an enterprise meeting predefined rating criteria;
generating, for display in a client device, a closed view of the web widget as an overlay on a web page of a web site associated with the enterprise upon the client device accessing the web page, wherein the closed view of the web widget include a set of avatars associated with the subset of workers;
receiving a selection of an avatar of the set of avatars via an input device of the client device; and
responsive to the selection, causing the client device to load an interface that enables submission of a rating for a selected worker of the subset of workers;
obtaining, via the client device, a user rating for the selected worker via the interface;
updating an overall rating for the selected worker based on the user rating and historical ratings for the selected worker; and
storing the overall rating to the database of the worker recognition server.

19. The method of claim 18, wherein dynamically selecting the subset of workers comprises:
obtaining a web cookie from the client device;
obtaining user identifier data for a user accessing the web page based on the web cookie; and
selecting the subset of workers based at least in part on the user identifier data.

20. The method of claim 18, wherein dynamically selecting the subset of workers comprises:
obtaining historical ratings for workers of the enterprise from the database; and
selecting the subset of workers based at least in part on the historical ratings.
